(19) United States
(12) Patent Application Publication
(10) Pub. No.: US 2015/0042492 A1
(43) Pub. Date: Feb. 12, 2015

(54) Traffic Control

(71) Applicant: Eugene F. Heacock, Southold, NY (US)

(72) Inventor: Eugene F. Heacock, Southold, NY (US)

(21) Appl. No.: 13/960,126

(22) Filed: Aug. 6, 2013

(51) Int. Cl. G08G 1/07

(52) U.S. Cl. CPC G08G 1/07
USPC 340/907

(57) ABSTRACT

A traffic control device is disclosed that enables users to direct traffic and signal to drivers. The traffic control device comprises an elongated component, a handle, at least one signal secured to the elongated component, a power source for powering the at least one signal, and a control panel for controlling the operation of the at least one signal. The signals are removably secured and interchangeable on the traffic control device, and can be any suitable shape or size. The signals can also be illuminated in different colors, such as red, yellow, green, or white. Additionally, the power source is typically a rechargeable battery. Further, the control panel controls the motion of the signals, such that the signals can be set to blink intermittently or remain constant. The control panel can be controlled manually by a user via push buttons, or can be controlled remotely via an electronic device.

### CROSS-REFERENCE

This application claims priority from Provisional Patent Application Ser. No. 61/680,311 filed Aug. 7, 2012.

### BACKGROUND

It can be dangerous and difficult to cross the street during heavy traffic, especially near school zones, at noisy construction sites, and/or if the normal traffic pattern is being diverted. Oftentimes, drivers may not be paying close attention, may be talking on their cell phone, and/or may only be watching out for other cars rather than pedestrians. Further, many schools employ crossing guards for nearby streets, but even crossing guards may have a difficult time directing traffic and getting drivers' attention. Thus, an effective solution is necessary.

The present invention provides users with a convenient way to alert drivers that people are crossing the street and/or that the normal traffic pattern is being diverted. The traffic control device may resemble a handheld stick with traffic light signals, arrow signals, and/or blinking lights. By using this device, users may safely cross the street, no matter their location, including at a school crossing zone, a construction site, a freeway crossing, a train station, a subway station, a bus crossing, or any variety of other places. Further, users may control the device by push buttons or by use of an electronic device, such as a tablet, smart phone, or laptop.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a traffic control device that enables users to direct traffic and signal to drivers, no matter the time of day, that people are crossing the street and/or that the normal traffic pattern is being diverted. The traffic control device comprises an elongated component, a handle, at least one light secured to the elongated component, a power source for powering the at least one light, and a control panel for controlling the operation of the at least one light. The lights are removably secured and interchangeable on the traffic control device, and can be any suitable shape as is known in the art, such as illuminated numbers, letters, arrows, circles, squares, and other shapes, etc. The lights can also be illuminated in different colors, such as red, yellow, green, or white. Additionally, the power source is typically a battery and would be rechargeable.

In a preferred embodiment, the elongated component could also comprise an indicator strip that displays the amount of power left in the batteries. Further, the control panel which controls the motion of the lights, such that the lights can be set to blink intermittently or remain constant, can be controlled manually by a user via push buttons, or can be controlled remotely via an electronic device, such as a smart phone, a laptop, or a tablet, etc. Additionally, the traffic control device comprises a handle or strap for attaching the device to a user's arm, or a stand for stand-alone operation of the device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the traffic control device including the removable lights in accordance with the disclosed architecture.

FIG. 2 illustrates a perspective view of the traffic control device secured to a user's arm in accordance with the disclosed architecture.

FIG. 3 illustrates a perspective view of different embodiments of the traffic control device in accordance with the disclosed architecture.

FIG. 4 illustrates a perspective view of the traffic control device being used by a user to direct traffic in accordance with the disclosed architecture.

FIG. 5 illustrates a perspective view of the traffic control device in a standalone configuration and being used by a user to direct traffic in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention provides users with a convenient way to alert drivers of people crossing the street and/or alert drivers that the normal traffic pattern is being diverted. The traffic control device may resemble a handheld stick with traffic light signals, arrow signals, and/or blinking lights. By using this device, users may safely cross the street, no matter their location, including at a school crossing zone, a construction site, a freeway crossing, a train station, a subway station, a bus crossing, or any variety of other places.

The disclosed traffic control device comprises an elongated component, a handle, at least one light secured to the elongated component, a power source for powering the at least one light, and a control panel for controlling the operation of the at least one light. The lights are removably secured and interchangeable on the traffic control device, and can be any suitable shape or size. The lights can also be illuminated in different colors, such as red, yellow, green, or white. Additionally, the power source is typically a rechargeable battery. Further, the control panel controls the motion of the lights, such that the lights can be set to blink intermittently or remain constant. The control panel can be controlled manually by a user via push buttons, or can be controlled remotely via an electronic device, such as a tablet, smart phone, or laptop.

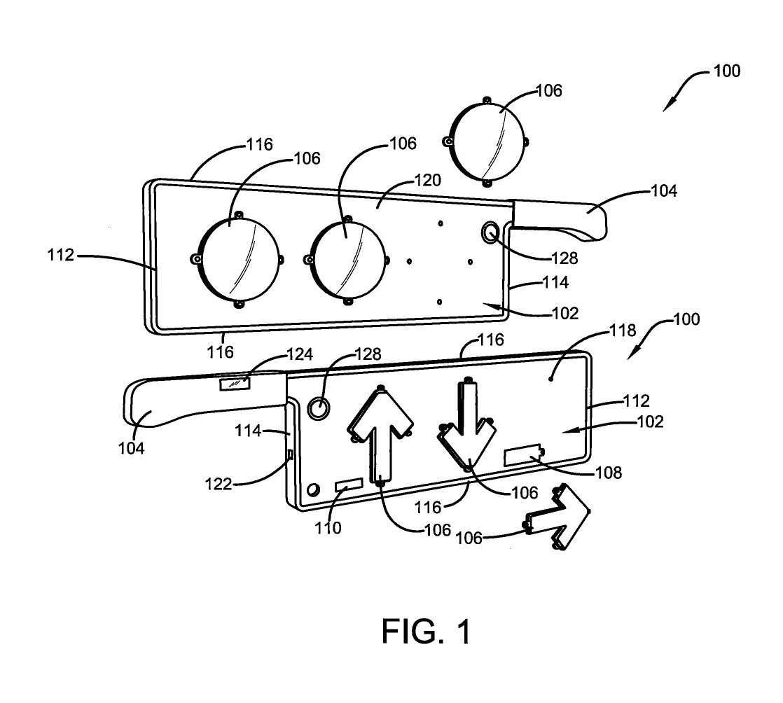

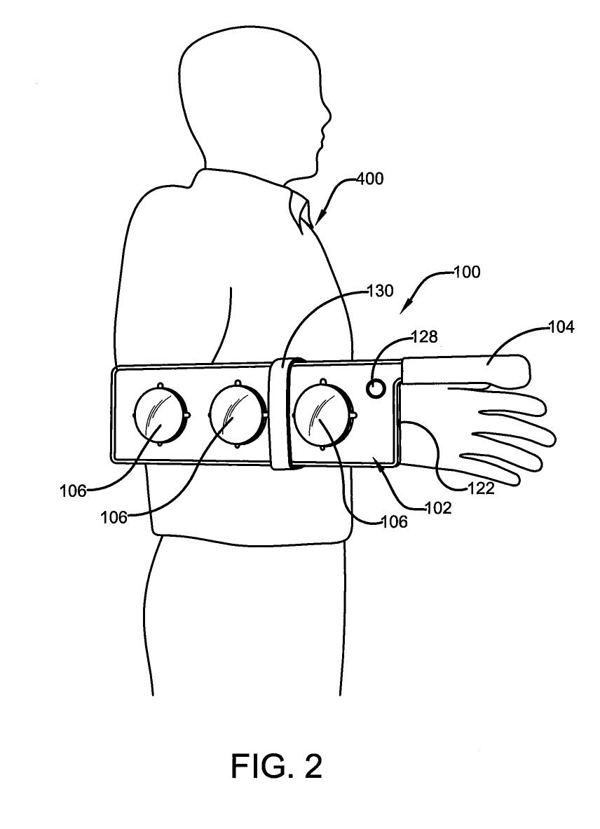

Referring initially to the drawings, FIGS. 1-2 illustrate the traffic control device 100 that enables users to direct traffic and signal to drivers, no matter the time of day, that people are crossing the street and/or that the normal traffic pattern is being diverted. The traffic control device 100 comprises an elongated component 102, a handle 104, at least one light 106 secured to the elongated component 102, a power source 108 for powering the at least one light 106, and a control panel 110 for controlling the operation of the at least one light 106 (as shown in FIG. 1).

The elongated component 102 comprises a first end portion 112, a second end portion 114, and opposing sides 116. Typically, the elongated members 102 can be any suitable shape as is known in the art without affecting the overall concept of the invention, such as rectangular, oval, or square, etc. The elongated component 102 would generally be constructed of homogeneous plastics, such as polyvinyl chloride (PVC), acrylonitrile butadiene styrene (ABS), polycarbonate (PC), etc., or sheet metal, though any other suitable material may be used to manufacture the elongated component 102 as is known in the art without affecting the overall concept of the invention, as long as the material is generally weather resistant.

The elongated component 102 can also comprise a variety of colors and designs to suit user and manufacturing preference. While the shape and size of the elongated component 102 may vary greatly depending on the wants and needs of a user, the elongated component 102 is approximately between 16 and 18 inches long as measured from the first end portion 112 to the second end portion 114, and approximately between 6 and 8 inches wide as measured from opposing sides 116, and approximately between 3 and 5 inches thick as measured from a front surface 118 to a back surface 120.

Typically, the elongated component 102 comprises a handle 104 or other suitable means for a user to grasp, hold, or retain the traffic control device 100. The handle 104 can be manufactured of the same materials as the elongated component 102 or any other suitable materials as is known in the art, and would typically be covered with a textured, non-slip gripping for ease in handling the traffic control device 100. Further, the handle 104 can be a separate component which is secured to the first end 112 or second end 114 of the elongated component 102 via gluing, welding, fastening, or any other suitable securing means as is known in the art. In contrast, the handle 104 could be manufactured as an integral unit with the elongated component 102.

The traffic control device 100 further comprises at least one light or signal 106 secured to and in electrical communication with a front surface 118 of the elongated component 102. Any suitable number of lights or signals 106 can be secured to the elongated component 102 as is known in the art. Further, the lights or signals 106 are removably secured and interchangeable on the traffic control device 100, such that the lights or signals 106 can be removed and a different shaped light 106 can be secured to the elongated component 102. Typically, the lights or signals 106 are secured via any suitable fasteners as is known in the art, such as screws, push nuts, etc.

Additionally, the lights 106 can be any suitable shape as is known in the art, such as illuminated numbers, letters, arrows, circles, squares, and other shapes or signals, etc. The lights 106 can also be illuminated in different colors, such as red, yellow, green, or white, or any other suitable colors as is known in the art, with each light 106 secured to the elongated component 102 being illuminated in a different color, or all of the lights 106 of the elongated component 102 could be illuminated the same color. Further, the lights 106 can be set to blink intermittently or remain constant, depending on a user's wants and/or needs. Thus, the lights 106 can be interchanged and/or customized, and any suitable combination of lights can be secured to the elongated component 102 depending on the needs and/or wants of the user or manufacturer. For example, the lights 106 can be put into a glove, or other device, the lights 106 would contain their own batteries and switches. Specifically, the lights 106 have small, self-contained batteries, and built-in switches with push triggers (i.e., user pushes a small button to operate), or hand-held remote control, or a plug-in wire connected to a hand-held control or connected to a switch on the user's belt, or connected to a voice-activated control, or wireless, etc. Further, devices 100 can be connected together to operate from a central switch or control.

Further, the traffic control device 100 comprises a power source 108 for powering the lights 106, and an on/off switch 128 positioned on the traffic control device 100 for powering the device 100 on and off. The power source 108 is typically a battery, but could be any other suitable powering means as is known in the art, such as an electrical cord, solar powered, etc. The power source 108 can be housed on any suitable position of the traffic control device 100, such as within the elongated component 102. If a battery is used as the power source 108, the battery would be rechargeable and the elongated component 102 could also have a port 122, wherein an electrical cable is inserted to charge the battery via a vehicle or other electrical outlet. Further, the elongated component 102 could also comprise an indicator strip 124 that displays the amount of power left in the batteries. The indicator strip 124 could also be positioned on any suitable location of the traffic control device 100, such as the handle 104.

The traffic control device 100 further comprises a control panel 110 for controlling the operation of the lights 106. The control panel 110 can comprise an integrated circuit board (ICB) which controls the motion of the lights 106, such that the lights 106 can be set to blink intermittently or remain constant, depending on a user's wants and/or needs. The control panel 110 can be controlled manually by a user via push buttons (not shown) on the traffic control device 100, or can be controlled remotely via an electronic device (not shown), such as a smart phone, a laptop, or a tablet, etc. The control panel 110 can be positioned on any suitable location of the traffic control device 100, such as the handle 104. Signals can be sent electronically to each unit (device 100), and units can be controlled with built-in switches and wires, as well as remote-controlled. For example, if the device 100 is placed in a glove, a user's hand can squeeze the device 100 to turn it on and off.

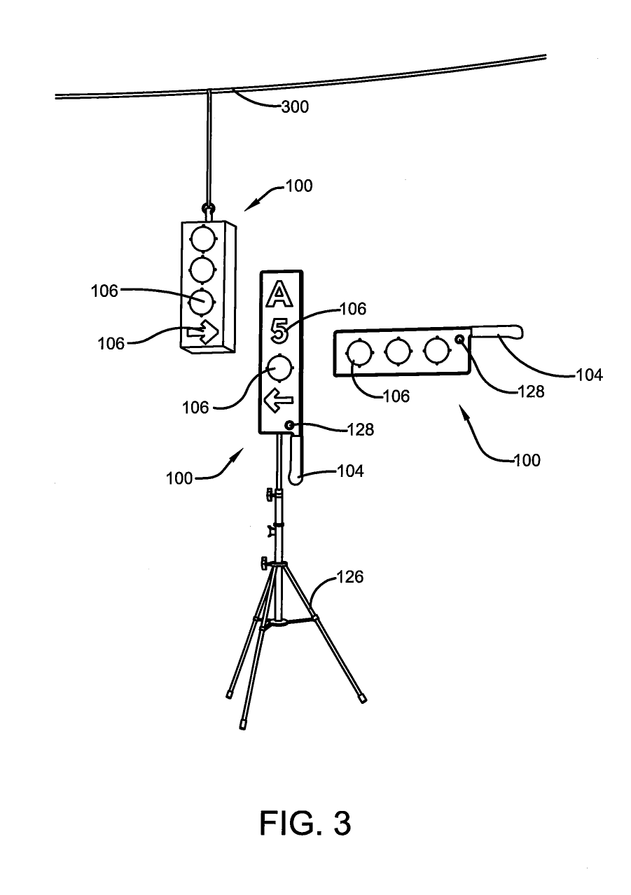

Furthermore, the traffic control device 100 comprises a stand 126 (as shown in FIG. 3) for supporting the traffic control device 100. The stand 126 can be any suitable shape and size as is known in the art, such as an inverted V-shaped structure, as long as the stand 126 supports the weight of the traffic control device 100 and allows the traffic control device 100 to be in a standalone configuration. The stand 126 is removable secured to the first end 112 or the second end 114 of the elongated component 102 via any suitable fastening means as is known in the art, such as nuts and bolts, screws, etc. The traffic control device 100 can also comprise a strap 130 or other suitable securing means as is known in the art to allow a user 400 to secure the traffic control device 100 to an arm or other part of the user 400 (as shown in FIG. 2).

FIG. 3 illustrates different embodiments of the traffic control device 100. As stated supra, the traffic control device 100 can be configured in various embodiments, such as secured to a traffic line 300 and suspended above traffic, similar to prior art traffic signals. Further, the traffic control device 100 can be configured as a standalone unit, wherein the stand 126 is secured to the first end 112 or the second end 114 of the elongated component 102, to allow the traffic control device 100 to be positioned upright on the road or other surface. Additionally, the traffic control device 100 can be used by a user via grasping its handle 104 in his/her hand and utilizing the traffic control device 100 as a regular crosswalk/pedestrian sign, or the user can secure the traffic control device 100 to his/her arm or other part of the body via a strap (as shown in FIG. 2).

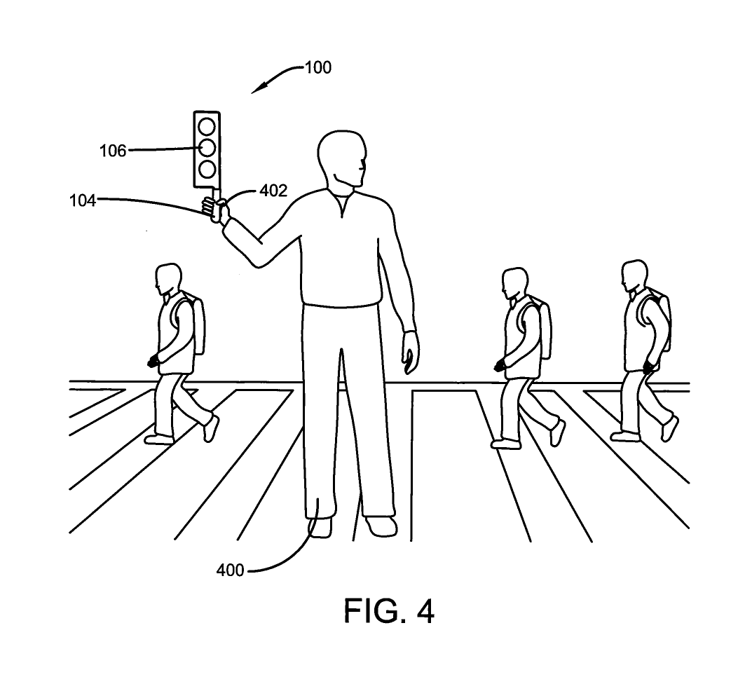

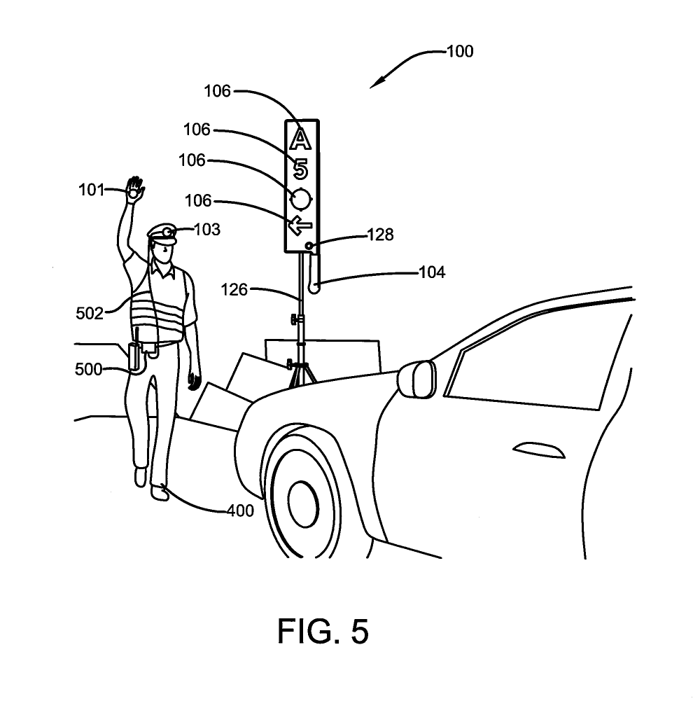

FIGS. 4-5 illustrate the traffic control device 100 being used by a user 400 to direct traffic. In operation, a user 400 would choose the size, shape, and/or design of the traffic control device 100 that meets their needs and/or wants. The user 400 would then configure the traffic control device 100 to meet their needs/wants, by removably securing various shaped lights 106 to the elongated component 102 and arranging the various shaped lights 106 in a specific pattern or order. Once the lights 106 are configured, the user 400 can then utilize the control panel 110 to control motion of the lights 106 and/or the colors of the lights 106. For example, the user 400 can set the control panel 110 to have the lights 106 blink intermittently, or remain constant. Furthermore, the user 400 can also set the control panel 110 to have the lights 106 illuminate in different colors, such as red, green, yellow, or white. Specifically, the user 400 can set the control panel 110 manually via push buttons on the traffic control device 100, or the user 400 can set the control panel 110 remotely via using an electronic device (not shown), such as a smart phone, tablet, or laptop.

Once the control panel 110 is set and the lights 106 configured to blink, remain constant and/or be illuminated in different colors, a user 400 can then turn the lights 106 on and utilize the traffic control device 100 to control traffic For example, the user 400 can grasp the handle 104 and hold the traffic control device 100 in his/her hand 402, utilizing the traffic control device 100 as a regular crosswalk sign/pedestrian sign (as shown in FIG. 4). The user 400 could also secure the stand 126 to the traffic control device 100, to position the traffic control device 100 in a standalone configuration (as shown in FIG. 5). Once the traffic control device 100 is secured to the stand 126, the user 400 can them place the traffic control device 100 in the area where normal traffic patterns are being diverted to help direct traffic. Furthermore, the traffic control device 100 can be incorporated into other articles, such as a user's glove 101 or a user's hat 103 (as shown in FIG. 5). Specifically, the lights 106 are controlled via small, self-contained batteries, and built-in switches with push triggers (i.e., user 400 pushes a small button to operate), or hand-held remote control, or a plug-in wire 502 connected to a hand-held control or connected to a switch 500 on the user's belt, or connected to a voice-activated control, or wireless, etc. Thus, the traffic control device 100 provides users 400 with a convenient way to alert drivers of people crossing the street and/or alert drivers that the normal traffic pattern is being diverted.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A traffic control device comprising:
an elongated component comprising a first end, a second end, and a front surface;
a handle secured to either the first end or the second end;
at least one signal secured to the front surface of the elongated component;
a power source for powering the at least one signal; and
a control panel for controlling the operation of the at least one signal.

2. The traffic control device of claim 1, wherein the power source is a battery.

3. The traffic control device of claim 2, further comprising an indicator strip that displays an amount of power left in the battery.

4. The traffic control device of claim 1, wherein the control panel allows a user to control the traffic control device remotely via an electronic device.

5. The traffic control device of claim 4, wherein the electronic device comprises at least one of a smart phone, a laptop, or a tablet.

6. The traffic control device of claim 1, wherein the at least one signal is a light.

7. The traffic control device of claim 1, wherein the at least one signal is removable and interchangeable.

8. The traffic control device of claim 7, wherein the at least one signal comprises at least one of an illuminated arrow, letter, number, or shape.

9. The traffic control device of claim 7, wherein the at least one signal can be illuminated in at least one of red, yellow, green, or white colors.

10. The traffic control device of claim 7, wherein the at least one signal can blink intermittently or be constant.

11. The traffic control device of claim 1, further comprising a stand for supporting the traffic control device.

12. A traffic control device comprising:
an elongated component comprising a first end, a second end, and a front surface;
a handle secured to either the first end or the second end;
at least one signal secured to the front surface of the elongated component;
a battery power source for powering the at least one signal;
an indicator strip that displays an amount of power left in the battery power source;
a port for charging the battery power source; and
a control panel for controlling the operation of the at least one signal.

13. The traffic control device of claim 12, wherein the at least one signal is removable and interchangeable.

14. The traffic control device of claim 13, wherein the at least one signal comprises at least one of an illuminated arrow, letter, number, or shape.

15. The traffic control device of claim 13, wherein the at least one signal can be illuminated in at least one of red, yellow, green, or white colors.

16. The traffic control device of claim 13, wherein the at least one signal can blink intermittently or be constant.

17. The traffic control device of claim 12, further comprising a stand for supporting the traffic control device.

18. The traffic control device of claim 12, wherein the control panel allows a user to control the traffic control device remotely via an electronic device comprising at least one of a smart phone, a laptop, or a tablet.

19. A traffic control device comprising:
an elongated component comprising a first end, a second end, and a front surface;
a handle secured to either the first end or the second end;
at least one signal secured to the front surface of the elongated component that is removable and interchangeable;
wherein the at least one signal comprises at least one of an illuminated arrow, letter, number, or shape;
a battery power source for powering the at least one signal;
an indicator strip that displays an amount of power left in the battery power source;
a port for charging the battery power source; and
a control panel for controlling the operation of the at least one signal; and
wherein the control panel allows a user to control the traffic control device remotely via an electronic device comprising at least one of a smart phone, a laptop, or a tablet.

20. The traffic control device of claim 19, further comprising a stand for supporting the traffic control device.
